(19) United States
(12) Patent Application Publication
(10) Pub. No.: US 2014/0108199 A1
(43) Pub. Date: Apr. 17, 2014

(54) METHOD AND USE OF POINT-OF-SALE TERMINAL, WHICH RECEIVES, TRANSMITS, STORES, AUTHORIZES, RECONCILES, AND CALCULATES TRANSACTIONS ELECTRONICALLY

(71) Applicant: Michael Surles, Arlington, VA (US)

(72) Inventor: Anita Surles, Manassas, VA (US)

(21) Appl. No.: 14/133,802

(22) Filed: Dec. 19, 2013

Related U.S. Application Data
(63) Continuation of application No. 13/252,848, filed on Oct. 4, 2011, now abandoned.
Application No. 13/252,848 is a continuation of application No. 10/157,126, filed on May 30, 2002, now abandoned.
Application No. 10/157,126 is a division of application No. 08/970,985, filed on Nov. 14, 1997, now abandoned.

(51) Int. Cl. G06Q 30/06; G06Q 50/18

(52) U.S. Cl. CPC G06Q 30/0613; G06Q 50/184
USPC 705/26.41

(57) ABSTRACT

A point-of-sale terminal, which receives, stores, transmits, authorizes, reconciles and calculates electronic transactions of data. It is also an on-line document delivery system which allows access, download, viewing and printing from a client's desktop, receive and send documents via facsimile to any location, and do virtually any other transaction offered by the System from home, office or from almost anywhere in the world at any time. This point-of-sale terminal is designed to provide access to documents through a graphical interface.

### CROSS-REFERENCE TO RELATED APPLICATIONS

This application is a continuation of U.S. patent application Ser. No. 13/252,848, filed Oct. 4, 2011, which is a continuation of U.S. patent application Ser. No. 10/157,126, filed May 30, 2002 (now abandoned), which is a divisional application of U.S. patent application Ser. No. 08/970,985, filed Nov. 14, 1997 (now abandoned), the contents of which are hereby incorporated herein by reference.

### FIELD OF THE INVENTION

The present invention relates generally to a point-of-sale terminal, which receives, stores, transmits, authorizes, reconciles, and calculates transactions electronically. In particular, the present invention relates to a network system with a database of U.S. patents, foreign patents, U.S. file wrappers, U.S. maintenance fee statuses, and other types of information available to the public from the U.S. Patent Office or a foreign Patent Office, which are offered electronically to client or subscriber.

### BACKGROUND OF THE INVENTION

The United States Patent Office is the sole source of information for patents and trademarks. The public can retrieve this information by either traveling to the Patent Office and copying the appropriate documents or by calling the different departments of the United States Patent Office and requesting information to be sent either by mail, courier, or facsimile. The caller must have either a prepaid deposit account, or a VISA/MASTERCARD for the United States Patent Office to fulfill an order. There is always the risk that deadlines for orders taken by the United States Patent Office personnel are not timely met.

There are many vendors in the patent industry that are retained by the patent legal community to provide U.S. Patent Office information. One vendor provides U.S. patent documents for downloading through the Internet from its Web site. Another vendor converts U.S. Patent Office magnetic tapes containing patent data to CD-ROM format. Others purchase these CDs from competitors in order to provide patent products to their own clients without having to use the U.S. Patent Office.

A U.S. file wrapper document is an example of information available to the public and obtained from the U.S. Patent Office. The public or vendor must go to the U.S. Patent Office and order the file wrapper from the File Information Unit, the receipt of this order could take up to 10 business days. Upon receipt, the public or vendor can copy the file wrapper at designated copiers in the U.S. Patent Office Search Room. The hard copy of the file is then forwarded to the vendor's client by mail, courier, or facsimile. Often, for a variety of reasons, file wrappers are not available from the U.S. Patent Office.

Another type of public information provided by the U.S. Patent Office is the payment status of a maintenance fee. The public or vendor can obtain this information from the U.S. Patent Office computers located in the Public Search Room.

### SUMMARY OF THE INVENTION

The problems of timely providing public information by the U.S. Patent Office are experienced daily by the patent legal industry. It would be faster, more orderly, and less expensive if all public information from the U.S. Patent Office was available through a point-of-sale terminal, which can receive, store information, transmit, authorize, reconcile, and calculate electronic transactions of public data. A client could download or receive data by electronic means and receive an invoice immediately within the same transmission. It would be ideal if a system could provide information on-demand electronically to remote sites to improve delivery of public information such that the public could make business decisions at the click of a button.

It is therefore an object of the present invention to provide information through a point-of-sale terminal, which receives, stores, transmits, authorizes, reconciles, and calculates electronic transactions of information.

It is a further object of the present invention to provide access to U.S. and foreign patent documents, U.S. file wrappers, payment status of maintenance fees, and all other information available to the public from the U.S. Patent Office or foreign Patent Offices via download, fax, courier, mail, and local pick-up.

It is a further object of the present invention to provide this access through a graphical client interface.

It is a further object of the present invention to provide a system that is adaptable to other computer operating systems (OS) for any industry, whether the storage platform is CD, hard drive, or magnetic tape media.

### BRIEF DESCRIPTION OF THE DRAWINGS

FIG. 1 presents a schematic view of the present invention.

### DETAILED DESCRIPTION

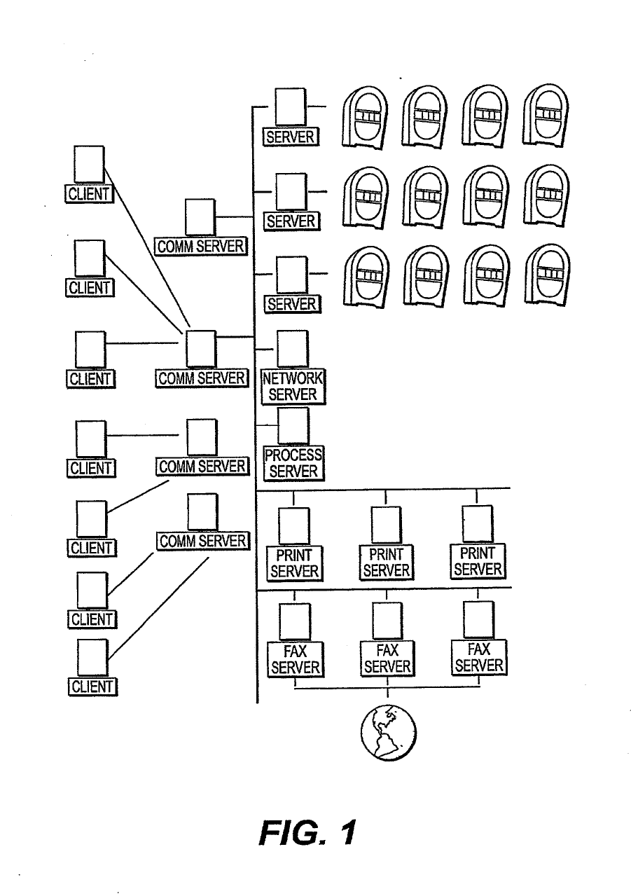

Referring to FIG. 1, an overview of the System is shown. One or more client serves 2 communicate with one or more COMM servers 4. COMM server 4 is connected to network server 8 which contains the System's master database. COMM server 4 obtains the status of the desired document and sends a request to job receive processor 10 to retrieve the document. Jukebox server 6 receives the Document Request Retrieval Transaction from job receive processor 10 and retrieves the desired document from the proper CD-ROM jukebox device 18. The retrieved document can either be printed or faxed to the client. If the retrieved document is to be printed, job receive processor 10 sends the retrieved document to print server 12. One or more print servers 12 can be implemented. If the retrieved document is to be faxed, job receive processor 10 sends the retrieved document to Fax server 14. One or more Fax servers 14 can be implemented. As shown, the documents can be sent anywhere in the world 16.

The System Network.

The file server includes magnetic hard disk storage devices. The primary hard disk is used to store the Network Operating System (NOS), the various program modules, and the database. A second hard disk is used to store some of the image files for a portion of the documents contained within the system. The network server 8 is a transport protocol such as IPX/SPX. At present, the network which supports the system is a closed network, where no direct access is possible from outside sources, e.g., the customer requires system software to access the network.

It will be helpful to describe the sequence of events, which takes place from a customer's perspective. An application (client server 2), running the customer's computer at a remote site, allows the customer to enter one or more document identifiers concerning the document, which the customer wishes to order. Along with the document identification, the customer also enters the method by which these documents should be returned to the customer. There are three choices for document delivery option: 1) the documents can be returned to the customer via a facsimile transmission (FAX); 2) the documents can be returned via an image download operation; 3) a printout can be mailed, or packaged for overnight courier or local pick-up.

The customer enters the necessary data using the software. Once the data is entered, the customer initiates a transfer and the software automatically accesses the system.

Sub-Systems.

There are several sub-systems which make-up the system of the present invention. These sub-systems, exclusive of network server 8, which is a commercial operation system, are print server 12, jukebox server 6, job receive processor 10, fax server 14, client server 2, administration, the local work station, and the Client system application.

Communication Server.

Comm server 4 handles all of the communication with client server 2, except for the outgoing fax data, which is handled by fax server 14. Comm server 4 receives communication initiated by the client application and directs the customer transaction to the appropriate sub-system within the system of the present invention. Comm server 4 also handles the download operation of sending document image files to the client application when the customer indicates that download is the desired mode of delivery.

Comm server 4 receives the customer's request, verifies that the customer is authorized to use the system, and verifies that the customer has sufficient funds in their account to cover the costs associated with the current transaction. In an alternative embodiment, if the order is for download, the Comm server 4 can verify the remaining disk space of the client's computer. It can also route completed transactions to a final destination, such as network fax server 14, or network print server 12.

Once verified, the Comm server 4 accesses the system's master database stored in network server 8, and obtains the status information for each document in the customer transaction. In the event that a customer orders a document which is not contained within the system, e.g., the customer makes a transcription error when entering the document number, a status message or error is sent back to the customer. The documents ordered are further processed by Comm server 4 by breaking up the transaction and building new transactions for each individual document. These individual transactions are then routed to one of three locations, depending on the delivery method selected for each document. If mail, courier or local pick-up was selected by the customer, the individual transaction is routed to print server 12. If fax was selected, the individual transaction is routed to fax server 14. If download was selected, the individual transaction is routed back to Comm server 4 and is sent to client server 2.

Each of these servers, print server 12, fax server 14, and Comm server 4, can initiate the process of retrieving the scanned image files for the documents requested. Each of these servers will build a document retrieval request transaction, which is routed to job receive processor 10. This document retrieval request transaction contains a unique identifier of the document requested, an indicator of the server requesting the document, and a location on the network where the retrieved document should be placed.

Job Receive Processor.

Job receive processor 10 acts as a funnel for each document retrieval request coming into the system. Using this functionality allows each process requesting a document to proceed independently to the document location. Other processes simply need to pass a request for a document to Job receive processor 10. Job receive processor 10 determines the location of the document, in terms of what media the document is stored on, what device is controlling that particular media, and exactly where the requested document resides on the media. Job receive processor 10, which has knowledge of all media access and control devices within the system, then passes the document request to the appropriate jukebox server 6 computer.

Job receive processor 10 processes a request and passes it onto the appropriate Jukebox server 6. In the event that the number of requests being made to the system creates a backlog, multiple job receive processor 10 can be placed on-line and can share the load, without interfering with the operation of one another.

The non-interference is accomplished by having all job receive processors 10 synchronize themselves with a master clock (the time of day clock on the network file server can be used for this.) Each job receive processor 10 is assigned specific clock ticks when that particular processor can do some work. For example, if each job receive processor 10 is set up to do work every 5 seconds, then the realistic limit on the number of job receive processor 10, which can run with no interference with one another, is five. The longer the time interval used for the job receive processor 10 the more job receive processor 10 can be run simultaneously. The use of a true multitasking operating system for the job receive processor 10 results in several job receive processor 10 running on a single multitasking computer by reducing the amount of hardware necessary to operate the present invention.

The job receive processor 10 reads the document locator database stored in network server 8 to determine exactly where the document is stored.

Document storage within the system can be in one of several difference locations. The system supports document storage on magnetic media in network server 8, in magnetic media in a specific computer within the network, and in CD-ROM media loaded into one of several CD-ROM jukebox devices 18 within the physical system network.

Job receive processor 10 determines which device contains the document, what media the document is stored on, and the exact storage location of the document on the media. Job receive processor 10 adds data to the Document Request Retrieval Transaction, which specifies this data and routes the Document Request Retrieval Transaction to the computer that controls the device which contains the document being requested. Job receive processor 10 processes the requests by sending them to the appropriate jukebox server 6. Job receive processor 10 locates the appropriate jukebox where the document resides and sends the request to the respective jukebox device to retrieve the document.

Jukebox Server.

Jukebox server 6, receives the Document Request Retrieval Transaction from job receive processor 10 and takes the necessary actions to retrieve the image file of the document image from the storage media. Once retrieved, the image file is placed in the location as specified in the Document Request Retrieval Transaction.

In the case of print server 12, the image file or files are sent to a hard copy printing device along with a cover sheet, which specifies the customer, the order number, the delivery method, the customer account balance, the document number, country code, document kind, the date and time of the transaction, etc.

Fax server 14 repackages the image file into a form which can be sent to a hard copy Fax device and then initiates the process of actually sending the image file to the Fax device at the number specified by the customer.

The Comm server 4 repackages the image file into an image packet which is routed to Comm server 4, then downloaded to client server 2.

The customer software does not allow the customer to configure any of its operating modules. During download, transfer of data is automatic. Further, if the customer places another order, previous orders on hold are processed at the same time as it is placing the new order. The client software initializes the download process. Once the download is complete, the communication session is terminated. At this point, the customer's software initiates an image viewer module built into the client software to allow the customer to view, print, and otherwise manipulate the image file.

The system can have multiple jukebox servers 6 installed, with each server running multiple CD-ROM jukebox devices 18 for storage and retrieval of patent information.

The number of Jukebox servers 6 which can be configured are limited by the network operating system running on network server 8 and the amount of physical space available to house the computers and the jukebox devices.

Jukebox server 6 software receives a request for a document from the job receive processor 10. This request contains the absolute location of the document being requested; the specific media containing the document, the location of the media, and the location of the document on the media.

Jukebox server 6, upon receipt of a request, will check to see if the media containing the document is available. This can happen if the media is a hard disk, either local to Jukebox server 6 computer or a network source, or if a previous request utilized the same media. If the media required is not already accessible, e.g., the CD-ROM is not currently mounted in the CD player, the Jukebox software issues the appropriate commands to the robot mechanism within the CD-ROM jukebox to load the CD-ROM into a drive reader. Once the media is accessible then Jukebox server 6 software initiates the process of reading the document image data from the media, converting the image data to a proper format such as TIFF CCITT Group 4 format, if required, and placing the document images into the location specified with the request.

Jukebox server 6 software tracks the time that a CD-ROM is loaded into a CD drive or player and remains inactive, e.g., not accessed by the Jukebox software. When this time exceeds a client defined maximum, jukebox server 6 software will automatically unload the CD-ROM. This technique is used for two reasons. First, the more times a CD-ROM is loaded into a CD player without being accessed, the more likely the CD-ROM substrate material could become damaged due to the heat generated by the CD player. Secondly, unloading a CD player which is not being used will shorten the time required to load a new CD-ROM for the next request because the unload robotic operation will have been completed.

When the job receive server retrieves a document from a jukebox, jukebox server 6 loads the appropriate CD into a drive, reads the information, and sends the information back through the network.

Print Server.

The Printer server's function is to receive a request for a document to be printed locally by the system and to take the necessary steps to physically print the document, along with an appropriate cover sheet. Requests for a document to be printed can arrive from the client server 2 as a result of a transaction submitted by the customer. Print server 12 receives the request, and sends a request to job receive processor 10 for retrieval of the document image data from the storage media, when the document image data becomes available, reformats the image data as necessary to send it to the print engine of the image printer. The image data can be reformatted into Post Script, HP PCL, or any other suitable format. In some cases the image data may not need to be converted.

Print server 12 prints patent documents, file wrapper documents, cover sheets, fax confirmation sheets, credit card sales receipts, or any other type of document requested for printing.

Fax Server.

Fax server 14 transmit documents to a facsimile machine. Fax server 14 receives requests from the client server 2 when the delivery method selected by the customer is a fax back or fax-to-other. Fax server 14 receives the request, sends a request to job receive processor 10 for retrieval of the document image data from the storage media, and when the document image data become available, reformats or converts the image data to a proper format, such as CCITT Group 3 format. Fax server 14 then initiates contact with the target Fax device and places the fax data onto the communication channel.

Upon completion of a fax transmission, the system reconciles the transmission data and sends this information to an available network printer for printing the confirmation sheet.

Administration Interface.

The Administration Interface (Admin) provides the facilities for the Present invention administrator to maintain the Present invention master database, through the addition of records, deletion of records, and updating the records when necessary. Administration functions are provided to extract certain data from various CD-ROM formats where the CD-ROM contains document images that are being added to the Present invention master database. In those instances where the database indexes may become corrupt for some reason, the administrator can execute a database re-index operation from within the Admin.

The Admin has a CD-ROM Locator Maintenance operation, a Pubs File Maintenance operation, an Import Part 1 and Import Part 2 operation (discussed in detail below), and an Index Files operation.

The CD-ROM Locator Maintenance allows viewing and editing of the locations of all CDs in the various jukeboxes and servers. It also lists the volume name of each CD, the status of each CD whether mounted or unmounted from the jukebox, the server name and location, the jukebox name, and the slot number in the jukebox. All types of data mentioned above are entered manually at this operation after CDs have been converted through the Import Part 1 and 2 operations.

The Pubs File Maintenance allows viewing and editing of any and all documents listed. It lists the entire database of documents by country code, document number, kind, page count, and the CD volume name. It also has a search engine, which requires entry of the country code, the document number, and the kind If a kind is not entered, the system finds the first “hit.” In the edit mode, it allows editing of all data of the document, including the path to which the document is found.

Index Files allow rendering of the Master Database. This is used only when the Master Database is corrupted or fails.

CD-ROM with records of image files are scanned and incorporated into the master database and the master Index. The system reads each record and converts these records into .FLT (“flat”) files. This operation is called Import Part 1. It then converts each record into .TLF files. This operation is called Import Part 2.

Local Work Station.

A local work station is not a normal part of the operational loop of the system. It is provided as a means for the system operator or supervisor to test various portions of the system in order to verify proper operation. Specifically, the operator can request a document to test job receive processor 10 and jukebox server 6. the operator can search the system master index database for a particular document, which would test the integrity of the database and its associated indexes. Additionally, the operator can retrieve and view on screen, which will further test jukebox server 6 and also test the accuracy of the document image file being created by jukebox server 6 software.

The Client Server.

The client installs the customer software in a standalone computer system. The software and hardware requirements for client server 2 are a Windows 95® software, minimum 8 mgs of RAM, and IBM compatible 486 PC or better, a laser printer with graphics capabilities, at least a 14,400 baud modem, and a telephone line, or T1 lines, or ISDN lines.

The client software automatically creates a system icon in the Windows “File Manager” screen. Clicking this icon initializes the system Registration Screen.

Registration Screen.

The Registration Screen requires entry of company data, such as the company or law firm name, the address, the suite number, the telephone number, the modem number, the speed of the modem, the brand name of the modem, the protocol, etc. When data entry in the Registration Screen is complete, the client clicks the “REGISTRATION” button. Client server 2 connects to the system communication server and transfers the registration data, which is then stored into a client database. After the system has recorded the registration information, a new screen is displayed. This new screen is the Order screen. The system network is now open to the client. However, the client is required to remit payment in advance to establish a deposit account. Payment to deposit accounts can be made by check or credit card. Credit card charges are accepted as payments for each transaction only. If there is a zero balance in the client's account and a credit card is not used, the system will not process the transaction until funds are credited to the account, or the credit card option is selected and completed.

If the client does not wish to enter a request at this time, the client clicks the EXIT button on the Registration screen. The system them displays the system Menu, which includes icons such as ORDER SCREEN, REPAIR, UPGRADE, FEES, and BANK ASSETS.

The REPAIR icon compacts and repairs the client's transaction database.

The UPGRADE icon is for upgrading the client's system software when new features or additional offerings are made available. Software upgrades are no longer sent by mail or courier service. Upgrades are sent electronically during communication when the client accesses the system network and transmits document requests. Upgrades are transmitted on-line on the client's computer before communication is terminated by client server 2, which takes place in the background. Before the communication terminates, the system sends a message to client server 2 that there is an upgrade. After communication terminates, the client exits out of the ORDER SCREEN. The system returns to the system Menu. The client clicks the UPGRADE icon, which allows client server 2 to accept new files and delete old files. When finished, a message displays advising the client that UPGRADE is complete.

Order Screen.

The ORDER SCREEN has several parts. There are windows for the docket, a contact, the client account number, the deposit account balance, the country code, the document number, and the kind There is a DELIVERY button, a grid listing all transactions, a SEND button, a VIEW IMAGE button, an ACCOUNTING REPORT button, and an EXIT button. At the bottom of the ORDER SCREEN is a STATUS BAR, which displays messages of what the System is doing, such as “sending the order,” “connecting to the System,” “verifying documents,” “verifying deposit account,” etc.

The DOCKET window is located at the top of the screen. A docket or file number or matter reference number is required to be entered here. The System will not allow the client to go any further until a docket and contact name are entered. The DOCKET window accepts alphanumeric entries.

The client can depress the ENTER key, or use the mouse and click to the CONTACT window, or use the TAB key to move the cursor to the next window. Here, the client enters the contact name or the person placing the order.

To the upper right of the screen is the Deposit Account Balance. The balance displayed here is the client's most current available funds. The balance decreases after each transaction. A new ending balance displays before the client exists the screen.

Country Code “CC” Window.

At left center of the screen is the “CC” (country code) window. A country code must be entered, e.g., the United States has a country code of US, France is FR, Belgium is BE, etc. Viewing of the country code listings is provided by clicking the down arrow button, which is adjacent to the CC window.

Documents offered are from countries such as but not limited to Austria (“AT”), Belgium (“BE”), Canada (“CA”), Switzerland (“CH”), Czech Republic (“CS”), German Republic (“DE”), Denmark (“DK”), European Patent Office (“EP”), Spain (“ES”), France (“FR”), Great Britain (“GB”), Hungary (“HU”), Italy (“IT”), Japan (“JPA or JPB”), Luxemborg (“LU”), the Netherlands (“NL”), Poland ({PL”), Romania (“RO”), the United States (“US”), the World Intellectual Property Organization (“WO”), and U.S. File Wrappers (“FH”).

Document Window.

Next to the country code window is the document number window. A patent number or an application serial number can be entered here. Most countries have the same patent numbering system with the exception of some U.S. patent documents, Japanese patent documents, World patents, etc.

For United States patent documents, a utility patent is entered with the published number. A U.S. design Pat., e.g., D234517, is entered with the character D+six digits. A U.S. Reissue Pat., e.g., RE31479, is entered with the characters RE+five digits. A U.S. plant patent, e.g., PP10059, is entered with the characters PP+five digits. A government document such as T103,801 is entered with the character T+6 digits. For a Statutory Invention Registration like H001680, it is entered with the character H+six digits.

For the U.S. file wrappers, the issued patent number is entered. For an abandoned file wrapper, the entry should be a series code plus the serial number of the file, e.g., Ser. No. 07/342,888 is entered as 07342888. A “SN” kind entry is required in the KIND window.

For a reexamination file, e.g., 90/001462, the entry should be 90001462 (90+six digits). Commas, hyphens, and slashes are not allowed in the document number window.

For a reissue file, e.g., RE12451, the entry should be RE12451 (RE+five digits).

Japanese patent numbers are treated differently. The client must convert a Japanese application such as JP 1-2249 “A,” to 01002249. The imperial year “1” must have two digits. A zero must be added before the “1”. The numbers after the hyphen is recognized as the serial number, which must have six digits. For a JP 1-2249 “A”, “2249” should be preceded with two zeroes, e.g., 002249. To enter the entire document, the entry should be “01002249” in the document window.

Kind Window.

Next to the document number window is the KIND window. The client enters the “KIND” of document requested. The client can select “A” for applications, “A1” for published applications with a search report, “A2” for the published application only, “A3” for the published search report, “A4 to A9” for a published amended application, “B1 to B3” for reexamination of the patent document, “C” for the actual Japanese patent up-to “C9,” depending on the originating country, etc. For a U.S. reexamined patent, the KIND entry is “RX”. However, depending on the number of times a U.S. patent was reexamined, the KIND also can be a “B1” or a “B2”.

For foreign countries such as the World Intellectual Property Organization, the kind can be an “A1, A2, A3,” etc. For European Patent Office documents, the kinds are “A1” or “B1”, “B2”, etc.

For Japanese Laid-Open documents, there is no kind entry required.

Delivery Options for Patents.

The DELIVERY button is located to the right of the KIND window. The client is provided with several DELIVERY options. The options are download, mail, pick-up, courier, fax back, and fax-to-other.

Additionally, there is an option to charge the current order to a credit card, such as VISA, MasterCard, American Express, etc. This option requires an entry of the credit card number, the expiration date, the name on the card, and the billing address. This data is then stored into the system's database. The system processes the credit card transaction and transmits a credit card sales receipt to the client server 2 before disconnecting. The credit card sales receipt itemizes all the charges. A copy of the credit card sales receipt also is printed to a network print server 12. This copy is then processed electronically for payment with applicant's merchant service card center.

For credit card charges of file wrappers already in the databases, the processing of the credit card is the same as that of a patent order. If the file wrapper is not in the database, the file is copied at the U.S. Patent Office, and scanned and written to CD-ROM. The CD is then scanned and its records are added into the Master Database through the Admin Program. The page count of the file is manually entered to the client's ledger. The next time the client connects to the System, the system calculates the credit card charges for the previously ordered file wrapper. The system then transmits the credit card sales receipt to the client server 2 before it disconnects.

Download Options.

When ordering is completed by the client, the SEND button is clicked, which allows client server 2 to dial-up the System. Once connected, client server 2 transfers all requests.

The System verifies each transaction by confirming the document numbers, the client's account and balance, hard disk space of client server 2 for download, and sends a message to the client's screen indicating the time it will take to download the order.

The system then sends another message asking the client to accept or cancel the DOWNLOAD. If accepted, the documents are sent immediately, along with an invoice. If the client cancels the DOWNLOAD, the order is terminated by the system. However, the order can be processed if the client reenters the order and selects a different delivery option.

Fax-Back Option.

Another feature of this invention is the ability to send documents back to the client's facsimile machine. The system sends the documents with a fax cover sheet.

If the document is to be delivered via fax-back or fax-to-other, the retrieved document and a fax cover sheet are sent to an available network fax server 14. Concurrently, the fax server 14 looks for the images. The fax server 14 transmits the documents to the client's fax machine or to another fax machine.

Fax-to-Other.

If this option is selected, the client enters the receiving company name, the name of the person to whom the facsimile is being sent, and the receiver's facsimile number. A “1” plus the area code must be entered along with the seven digit facsimile number. To send a facsimile outside the United States, the client enters 011 plus the country code, the city code and the facsimile number.

Courier.

If the document is to be delivered via courier, or local pick-up, the System sends the retrieved documents to an available network printer, along with a cover sheet. The cover sheet has the client's data and detailed description of the transaction, including the balance of the deposit account. The documents are then manually packaged for shipment. The client can ship documents via Federal Express, DHL, Airborne, U.S. postal service, or local pick-up by providing the courier account name and number. A cover page for each document requested are printed at the system's print server 12 and is packaged for the designated courier. The cover page recites the client's transaction, including account balances and shipping information.

The courier option is handled the same was as mail or pick-up with two exceptions. The client must enter the courier name, e.g., FedX, or DHL, etc., and the account number.

Packaging of File Wrappers.

The options for packaging a file wrapper are several. These options are “hole-punch,” “file dividers,” “references,” “certified copy of application as filed,” “certify references,” “PTO Deposit Account,” “fax back,” “fax to other,” “courier,” “charge my VISA,” “charge my Master Card,” etc.

For “hole punch,” the file is sent back to the client with a two-hole punch at the top margin of each page of the file. A prong and fastener is used to keep the file together.

For “file dividers,” the file is sent to the client with legal size paper dividers that have bottom tabs. The tabs are inserted in front of the document and sequentially numbered according to the Paper Number written or typed on the face of each document.

For “references,” the file is sent back with all the cited art listed on the face of the patent, including all publications.

For “certify application as filed,” a written request is made to the Certification Branch of the U.S. Patent Office to certify the application in the file as filed. After the document has been certified by the Patent Office, the document is shipped to the client.

For “certify references,” a written request is made to the Certification Branch to certify the references that were cited on the face of a patent.

The DELIVERY options for file wrappers are the same as for patents, except the download and mail options are not offered.

SEND Button.

After selecting a delivery option, the client exists the screen by clicking the EXIT button. The system returns to the ORDER SCREEN. The ORDER SCREEN displays a list of the requested documents inside the grid, including mode of delivery. The order can now be sent to the System network by clicking the SEND button.

ACCOUNTING Button.

The system automatically debits the client's deposit account after each transaction. A new beginning balance is then displayed in the ACCOUNT BALANCE window of the ORDER SCREEN. The deposit account is accessible 24 hours per day.

Another feature of the account system is that it can reconcile a client's account.

Another feature is the automatic report generator. An invoice is generated automatically at the client printer after each order. The client also can obtain the same invoice or other accounting reports through the account screen. The accounting screen provides options such as Report by Statement, Report by Invoice, and Report by Docket.

For a year-to-date or month-to-date statement, the beginning and ending dates must be entered. For an invoice, the invoice number must be entered. For a report by docket, the docket must be entered. With this reporting feature, clients no longer receive statements or invoices by mail. The client can send invoices immediately to his own clients for reimbursement.

Yet another feature of the accounting system is the ability to calculate fees for each transaction and stores the fee information into the system's client ledger. The same fee is transferred to the client's computer during connection. If a document is sent as a hard copy by mail, the system calculates the number of pages of that document and charges for postage.

A handling fee is also calculated by the system, which adds the charge to the client's account ledger as a debit. This packaging and handling fee is applied to all deliveries except download and local pick-up.

Additionally, the deposit account is charged a monthly service fee. The system debits this fee on the first day of each new month.

If the client's deposit account has a small balance, the system completes only transactions that can be debited from the client's deposit account balance.

The system will not process a transaction if the deposit account has a zero balance. The transaction is placed on “hold” until funds are received. The system displays a message advising the client to replenish the deposit account.

When funds are received for a deposit account, the payment is manually entered and credited to that deposit account. The transactions previously on “hold” are processed automatically on the next call. A new beginning balance is displayed in the ACCOUNT BALANCE window of client server 2.

Although the system of the present invention has been described in detail for purpose of illustration, it is understood that such detail is solely for that purpose, and variations can be made therein by those skilled in the art without departing from the spirit and scope of the invention. The system of the present invention is defined by the following claims.

What is claimed is:

1. Apparatus for selling a U.S. patent file history to a remote customer having a computer, over a wide area network, comprising:
storage structure configured to store a plurality of U.S. patent file histories; and
communication processing structure, coupled to the remote customer's computer over the wide area network, and coupled to said storage structure, and configured to: (i) provide the remote customer's computer with information for the remote customer to identify themselves, order a U.S. patent file history, and retrieve the ordered U.S. patent file history; (ii) verify the remote customer's identity; (iii) verify that the remote customer has sufficient funds to pay for the ordered U.S. patent file history; (iv) obtain status information corresponding to the ordered U.S. patent file history; (v) in the event that the ordered U.S. patent file history is not stored in said storage structure, provide a corresponding status message to the remote customer's computer; and (vi) in the event that the ordered U.S. patent file history is stored in said storage structure, and after verifying the remote customer's identity and verifying that the remote customer has sufficient funds to pay for the ordered U.S. patent file history, cause the ordered U.S. patent file history to be provided to the remote customer.

2. Apparatus according to claim 1, wherein said communications structure is configured to cause the ordered U.S. patent file history to be provided to the remote customer via at least one of (i) downloaded file, and (ii) faxed document.

3. Apparatus for selling a U.S. patent file history to a remote customer having a computer, over a wide area network, comprising:
storage structure configured to store a plurality of U.S. patent file histories; and
communication processing structure, coupled to the remote customer's computer over the wide area network, and coupled to said storage structure, and configured to: (i) provide the remote customer's computer with information for the remote customer to identify themselves, order a U.S. patent file history, and retrieve the ordered U.S. patent file history; (ii) verify the remote customer's identity; (iii) obtain status information corresponding to the ordered U.S. patent file history; (iv) in the event that the ordered U.S. patent file history is not stored in said storage structure, provide a corresponding status message to the remote customer's computer; and (v) in the event that the ordered U.S. patent file history is stored in said storage structure, and after verifying the remote customer's identity, cause the ordered U.S. patent file history to be provided to the remote customer,
wherein said communications structure is configured to provide the remote customer's computer with delivery information by which the remote customer may choose the ordered U.S. patent file history to be provided by any one of: (i) paper copy, (ii) facsimile machine, and (iii) downloaded to the remote customer's computer.

4. Apparatus according to claim 3, wherein said communications structure is configured to provide the remote customers' computer with information by which the remote customer is required to enter a docket number corresponding to the ordered U.S. file history.

5. Apparatus according to claim 3, wherein said communications structure is configured to provide to the remote customer's computer billing information corresponding to the ordered U.S. file history.

6. Apparatus according to claim 3, wherein said communications structure is configured to provide the remote customer's computer with ordering information including at least one of: (i) country identification, (ii) document number, and (iii) type of document.

7. Apparatus according to claim 3, wherein said structure stores the plurality of U.S. patent file histories as image files.

8. Apparatus according to claim 3, wherein said communications structure is configured to provide the information to a plurality of remote customers' computers, wherein the plurality of remote customers' computers have different operation systems.

9. Apparatus according to claim 3, further comprising a plurality of storage structures, each storing a plurality of U.S. patent file histories, and wherein said communication processing structure is configured to provide to the remote customer a U.S. patent file history from any one of said plurality of storage structures.

10. Apparatus according to claim 9, further comprising job processing structure, coupled to said communication processing structure and to said plurality of storage structures, and configured to determine in which of said plurality of storage structures the ordered U.S. patent file history is stored.

11. Apparatus according to claim 10, wherein said job processing structure is configured to multitask process a plurality of orders for U.S. patent file histories from a plurality of remote customers' computers.

12. Apparatus according to claim 3, further comprising fax processing structure, coupled to said communication processing structure and to said storage structure, and configured to convert the ordered U.S. patent file history stored in said storage structure into a fax format document.

13. Apparatus according to claim 3, further comprising print processing structure, coupled to said communication processing structure and to said structure, and configured to convert the ordered U.S. patent file history stored in said storage structure into a print format document.

14. Apparatus according to claim 3, wherein said communication processing structure is configured to convert the ordered U.S. patent file history stored in said storage structure into a download format file.

15. Apparatus for providing a U.S. patent file history to a remote customer's computer through the Internet, comprising:
a plurality of storage structures each configured to store a plurality of U.S. patent file histories;
communication processing structure, coupled to said plurality of storage structures, and coupled to the remote customer's computer over the Internet, and configured to: (i) receive from the remote customer's computer information which identifies the remote customer; (ii) receive from the remote customer's computer information which orders a U.S. patent file history; (iii) obtain status information corresponding to the ordered U.S. patent file history; (iv) in the event that the ordered U.S. patent file history is not stored in any of said plurality of storage structures, provide a corresponding status message to the remote customer's computer; and (v) in the event that the ordered U.S. patent file history is stored in at least one of said plurality of storage structures, download the ordered U.S. patent file history to the remote customer's computer; and
job processing structure, coupled to said communication processing structure and to said plurality of storage structures, and configured to determine in which of said plurality of storage structures the ordered U.S. patent file history is stored, said job processing structure being configured to multitask process a plurality of orders for U.S. patent file histories from a plurality of remote customers' computers.

16. Apparatus according to claim 15, wherein said communication processing structure is configured to convert the ordered U.S. patent file history into a download format file.

17. Apparatus according to claim 15, further comprising fax processing structure, coupled to said communication processing structure and to said plurality of storage structures, and configured to convert the ordered U.S. patent file history into a fax format document.

18. A method for providing a U.S. patent file history to a remote customer's computer through the Internet, comprising the steps of:
providing a plurality of storage structures each configured to store a plurality of U.S. patent file histories;
receiving, at a communication processing structure coupled to said plurality of storage structures, information from the remote customer's computer which identifies the remote customer;
receiving, at the communication processing structure, information from the remote customer's computer which orders a U.S. patent file history;
determining, with a job processing structure, whether the ordered U.S. patent file history is stored in any of said plurality of storage structures;
in the event that the ordered U.S. patent file history is not stored in any of said plurality of storage structures, providing a corresponding status message to the remote customer's computer; and
in the event that the ordered U.S. patent file history is stored in at least one of said plurality of storage structures, downloading the ordered U.S. patent file history to the remote customer's computer.

19. A method according to claim 18, wherein said job processing structure multitask processes a plurality of orders for U.S. patent file histories from a plurality of remote customers' computers.

20. A method according to claim 18, further comprising the step of verifying that the remote user has sufficient funds to pay for the downloaded U.S. patent file history.
